(19) United States
(12) Patent Application Publication
(10) Pub. No.: US 2010/0306197 A1
(43) Pub. Date: Dec. 2, 2010

(54) NON-LINEAR REPRESENTATION OF VIDEO DATA

(75) Inventors: Sheng Jin, New Territories Hong Kong (CN); Sze Lok Au, New Territories Hong Kong (CN)

Correspondence Address: EGBERT LAW OFFICES, 412 MAIN STREET, 7TH FLOOR, HOUSTON, TX, 77002, US

(73) Assignee: MULTI BASE LTD, NEW TERRITORIES , HONG KONG (CN)

(21) Appl. No.: 12/739,558

(22) PCT Filed: May 27, 2008
(86) PCT No.: PCT/CN08/01026

§ 371 Date: Apr. 23, 2010

(51) Int. Cl. G06F 17/30

(52) U.S. Cl. 707/736; 707/E17.044; 707/769; 707/E17.014

(57) ABSTRACT

The present invention is a method of representing video data in a non-linear paradigm. Video data are categorized into semantic content comprising multi-layer structure each denotes semantic reference, such as different cinematic entities. The semantic content is organized in a hierarchical structure where the top layer denotes global information while the lowest layer represents primitive information. The cinematic entities in the top layer are hyper-linked to the entities in the second layer. The entities in the second layer are hyper-linked to the third layer and so forth. Each cinematic entity in the lowest layer is designated to a part of the video content and hyper-linked to the corresponding video data. The semantic content comprises hyper-linked video data in an N-to-N relationship. N-to-N relationship means the data are hyper-video and the video data supports multiple access and multiple presentation. An apparatus for presenting categorized semantic content is also disclosed.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to method of representing video data in a non-linear way.

2. Description of Related Art Including Information Disclosed Under 37 CFR 1.97 and 37 CFR 1.98.

Currently, video viewing and representation are done in a linear fashion. Videos are represented in a frame basis and videos are viewed frame by frame in an incremental order. Video categorization and searching are all managed in a temporally linear manner. That is, video segments are divided in a linear time line base fashion. During a video search, the systems can direct to a particular frame. Most video features such as fast forward and rewind are linear base operations.

Currently, websites such as YouTube allow tagging keywords to video data. Users can search for videos by typing keyword(s) and match with those tagged with the videos on the website. This technique enables query by examples. However, it is very difficult to search a video if the user cannot think of the exact keyword to search.

There are prior art techniques which allow video indexing based on low level visual features such as color, texture, and motion. Key-frames and scenes are selected to roughly represent the video in a compressed way. However, the key-frames and scenes can only be viewed by the eye and therefore not scalable to searching against a videos database. Another prior art matches the key-frames against a frame library containing model frames such as car, flower, dog, etc. The matching results will be used to index the video content. However, it comes back to the same limitation of linear indexing where video data can only support keyword searching. The current stage of technology has limited capability and cannot utilize the full potential of video data.

### BRIEF SUMMARY OF THE INVENTION

The present invention provides a non-linear base video representation and a method for the representation of video data. Such representation provides capabilities to the system for non-linear video viewing and searching.

Video data is presented as multi-layer structure where each layer denotes different cinematic entities. At the top layer of the structure is general abstract information while detailed information is denoted at the primitive layer. The video data is categorized into semantic video data which are hyper-linked in an N-to-N relationship. The video data becomes hyper-video and the video data supports multiple access and multiple presentation.

The present invention comprises an apparatus for presenting the categorized video data to users. The semantic data can be described as plain text format. Users can browse the semantic data from the top layer down to the lowest layer. The hierarchical structure of the semantic data is presented as relationship diagram. Users can view each part of the video corresponding to each semantic data as a separately played short video.

The present invention further comprises an apparatus for performing searching on a repository of semantic video data. Users can specify keywords to be searched in the semantic contents of the categorized video data. An ontology search can possibly be performed on the semantic contents wherein the search is based on hierarchical relations other than just keywords. A generic permutation and clustering algorithm is employed to group contents and relate contents to each other.

Videos can be categorized according to their contents, semantic meaning, events, etc. Users can therefore select to view and search any particular content from videos.

Semantic Meaning Relationship and Ontology

From the lowest object level to the top scene level, semantic meaning is given to each video data instance. The present invention adopts the ontology approach for the organization of the semantic description. Ontology is a state-of-the-art knowledge management methodology and is commonly used to describe relationship between concepts. Definitions and implementations of ontology are described in many technical web sites such as <http://www.w3.org/TR/webont-req/>. For example, a frame contains the object Mount Fuji, which belongs to the group of geographical mountain and the country Japan. In the next level, Japan belongs to Asia.

### BRIEF DESCRIPTION OF THE SEVERAL VIEWS OF THE DRAWINGS

The accompanying drawings, which are incorporated in and constitute a part of this disclosure, illustrate various embodiments and aspects of the present invention. In the drawings:

FIG. 1 is a schematic view illustrating the video data multi-layer structure of the present invention.

FIG. 2 is a schematic view showing the linear view of video presentation.

FIG. 3 is a schematic view showing a sample logical view.

FIG. 4 is a schematic view showing the process of categorizing a conventional media data.

FIG. 5 is a schematic view of a preferred embodiment of the apparatus for presenting the categorized semantic data.

FIG. 6 is a schematic view showing the data flow in a media search.

### DETAILED DESCRIPTION OF THE INVENTION

The following detailed description refers to the accompanying drawings. Wherever possible, the same reference numbers are used in the drawings and the following description to refer to the same or similar parts. While several exemplary embodiments and features of the present invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the present invention. Instead, the proper scope of the present invention is defined by the appended claims.

The present invention provides a method for the representation of video data in a semantic and non-linear hierarchical structure and a presentation model of the video data.

Instead of representing video as a mere sequence of frame entity, the present invention represents video data units in a content based structure. In particular, video data is presented as multi-layer structure where each layer denotes different cinematic entities. At the top layer of the structure is general abstract information while detailed information is denoted at the primitive layer.

Videos can be categorized according to their contents, semantic meaning, events, etc. Such categorization is realized by creating certain tags having fields allocated thereto at least one semantic reference. The semantic references include information about records having a field with at least one semantic reference.

Users can therefore select to view and search any particular content from videos. Such content is of video file data carrying tags having the same semantic reference. In preferred embodiments, such contents are arranged and represented in series. For example, news clips can be grouped into various categories such as cast, events, dates, locations and themes. Historical tennis tournaments can be classified into categories such as tournaments, serves, volleys, unforced errors and players. Movies can be grouped into categories such as cast, events and locations.

With the ontology support for semantic contents searches, the semantic content repository becomes a valuable resource for various users. For example, news videos can be more organized in a TV station, historical sports events can be easily retrieved by personnel such as coaches.

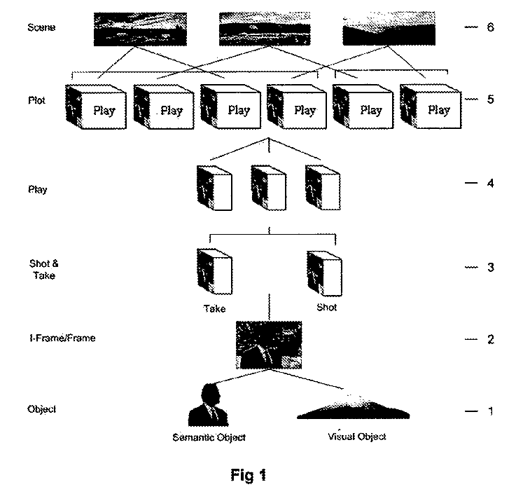

FIG. 1 illustrates the video data multi-layer structure, and for the purpose of illustration, with six layers of scene, plot, play, shot, take, frame and object. The most primitive level 1 is an object. It can be a meaningful semantic object such as people, car, building, beach, sky, or a visually sensible region such as a region of the same color, similar texture, etc. which is a visual object. It can also be an interactively grouped region. Semantic objects and visual objects form the concept of perceptual objects. The hierarchical structure of the semantic content can be visualized logically as a relationship diagram and key-frame presentation.

The next level is a frame 2. An object is a region in a frame. A frame is the conventional and physical representation of the basic unit of video data. A sequence of frames forms a video where typically one second of video contains twenty five frames. A frame is one complete unit in presentation. A stack of consecutive frames forms a video sequence. An I-frame is an identification frame among a group of frames. It is consistent with the definition of I-frames in the MPEG compression standard.

Level 3 denotes shot and take. A take is a sequence of frames which contain one action of a perceptual object. An action is a continuous movement performed by an object as shown in a sequence of frames whereas the movement processes semantic meaning. For example, a play can be a sequence of frames starting from when a person starts walking to when the person stops walking It is the smallest sequence to describe an action. A shot is a sequence of frames, which give a clear description of certain perceptual objects. For example, a shot can be a sequence of frames starting from when a car appears to when the car disappears. It is the smallest unit to describe a perceptual object.

Both takes and shots are abstract cinematic entities. They can appear on the same sequence of frames and do not necessarily have any physical relationship to each other.

A video containing multiple perceptual objects performing many actions at the same location forms a play 4. A location is a visual object that acts as the background for a video shot. The same location can appear multiple times in a video. The appearance of the location can be taken from different cinematic angles.

The collections of all plays 4 from the same locations form a scene 6 while multiple plays developed under the same story form a plot 5. Note that the definition of the layers allows overlapping between takes and shots, and plots and scenes.

In alternative embodiments, different number of layers in the multi-layer structures may be adopted for various kinds of video data. For example, for films video data searching and presentation, the comparatively global information can be adopted to be the origins of the movie production, the names of film companies and/or the years of production.

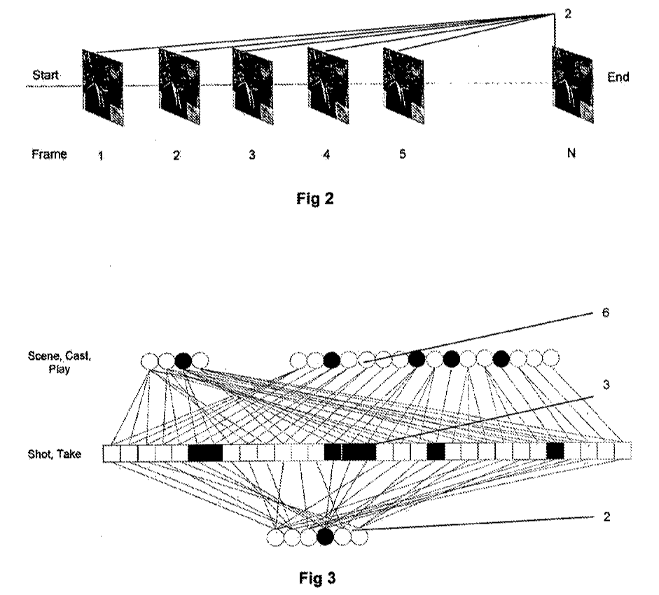

FIG. 2 gives a graphical presentation of the conventional linear video data structure. In conventional video data representation paradigm, video frames 2 are linked in a linear fashion. That is, a video frame has one and only one video frame preceding it, and one and only one frame following it.

FIG. 3 shows a sample logical view. Video data that are categorized into layers of semantic information are inter-related hierarchically. The relationship is given in a logical view. Notice that each video clip forms a N-to-N relationship to other clips. N-to-N relationship means the data are hyper-video and the video data supports multiple access and multiple presentation. These clips are connected by semantic relationship rather than temporal relationship.

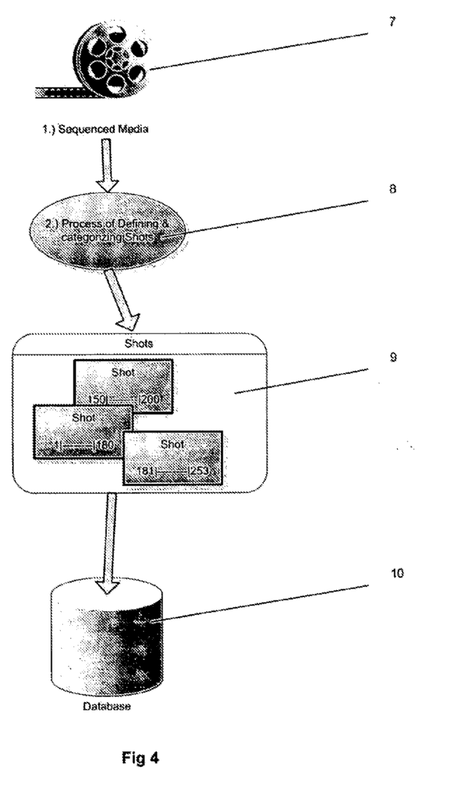

FIG. 4 shows the process of categorizing sequenced media data. Sequenced media 7 contents a pre-defined sequence of frames which it is supposed to be rendered with. For example: a movie, an audio recording, a pre-programmed virtual-world scene, a collection of week-to-week statistical data, etc.

In the Process of Defining and Categorizing Shots 8, parts of the sequenced media 7, sections which are of particular interest, are identified and given some categorizing information, such as searchable text description. Such an identified section is referred to as a shot 9. The Shots can be defined manually or programmatically by applying appropriate domain dependent algorithms. The result of this process is a collection of Shots.

Each Shot is comprised of a reference to the original media, the beginning and ending frames, sequence number, time-marks and the categorizing info. A Shot only contains information that refers to parts of the original media.

A Shots Repository 10 is used to store the Shots objects identified above, ready to be searched and retrieved. Shots are further grouped into plays, plots, scenes, etc.

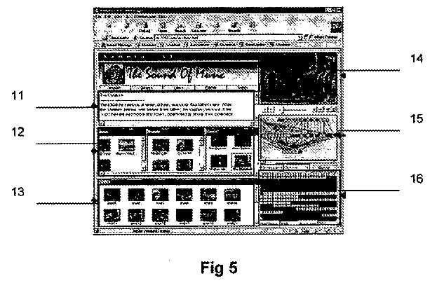

FIG. 5 shows a preferred embodiment of the apparatus for presenting the categorized semantic data at different levels. It is preferable to have a video file data representation apparatus for representing video file data to be represented. Such an apparatus is configured to store a a computer program with a graphical user interface for users to access the categorized semantic information of video data. At the lowest level, the categorized video can be linearly visualized and played piece-wise without transcoding. At the browsing level, the hierarchical structure of the semantic data can be visualized logically as a relationship diagram and a key-frame presentation.

The semantic representation of the video is displayed as text on the Text Window 11 wherein user can browse the content of the video.

Similar to conventional presentation, at the physical level, video can be shown in a content page. There is provided a linear view in the Play Window 14. In this presentation, video data is visualized as a frame by frame sequence. The present invention allows frames to be grouped into shots and takes. The sequential linkage of shots and takes forms the whole video. These shots and takes are shown in low-level view 13.

According to their contents, shots and takes can be classified into various categories. Users can define categories dynamically for each video. Sample categories are cast, events, locations, plays and scenes. These semantic categories are presented as high-level view 12.

Video data that are categorized into layers of semantic information are inter-related hierarchically. Tags containing semantic references for video file data are created to contain information about records having a field with at least one semantic reference on the said video file data. Such tags facilitates search and retrieval by the users. The hierarchical relationship is given in a logical view 15.

The Visualization Window 16 shows the physical location of each scene, play, shot or take relative to the whole video.

A preferred embodiment of the apparatus for performing searching on a repository of semantic video data is a search engine-like computer program. The categorized video data are stored in a database repository. Video data at different levels of the hierarchy are grouped by a generic permutation of key frames and a clustering algorithm for shot regrouping.

The video data representation is carried out by an apparatus for representing video file data to be represented. Said video file data to be represented carrying tags having fields allocated thereto at least one semantic reference and further a specified layer in a multi-layer hierarchical structure and being constructed so that video file data carrying tags having the same semantic reference are arranged and represented in series. The apparatus comprises a plurality of tags containing semantic references for video file data, the semantic references including information about records having a field with at least one semantic reference on the said video file data to be searched, and containing information of a specified layer by classifying the said video file data to be searched by using a plurality of hierarchical levels. The apparatus provides an input unit for giving an instruction to search for tags relating to a specified semantic reference on the said video file data to be searched and to search for tags relating to a same semantic reference and of a specified layer in the hierarchical levels on the said video file to be searched; a retrieving unit for retrieving from tags the information about records having same semantic references and a specified layer in the hierarchical levels on the said video file data to be searched; an extracting unit for extracting from the video file data carrying tags having specified semantic references and specified layer in the hierarchical levels; and a representation unit for representing extracted video file data carrying the tags having the specified semantic references and the specified layer in the hierarchical levels in series.

Preferably, this invention provides a computer-readable memory product for instructing a computer to representing video file data and such memory product storing a program to instruct a computer to accept an instruction to search, retrieve and extract tags relating to a specified semantic reference and represent extracted video file data carrying the tags having the specified semantic references and the specified layer in hierarchical levels in series.

Contrary to conventional video searching where users can only perform a linear search such as fast-forward/rewind and jump to chapters, the present invention allows applications to perform ontology search over the semantic content repository. For example, when a user searches for volley drill in a tennis video, the ontology support automatically links with forehand volley and backhand volley. In another example, users can search for particular shots by specifying contents. For example, users can search for Bill Clinton and the system will returns all shots and takes that contains Bill Clinton.

Users can perform browsing on video. This is not possible in convention linear video data presentation methodology. For example, users can select a country, such as United States, and browse the contents under this category. Under the category States, there would be sub-categories including the president, and in turn, the sub-category president would include Bill Clinton. Selection Bill Clinton would list out all the video clips that contain Bill Clinton from the video records.

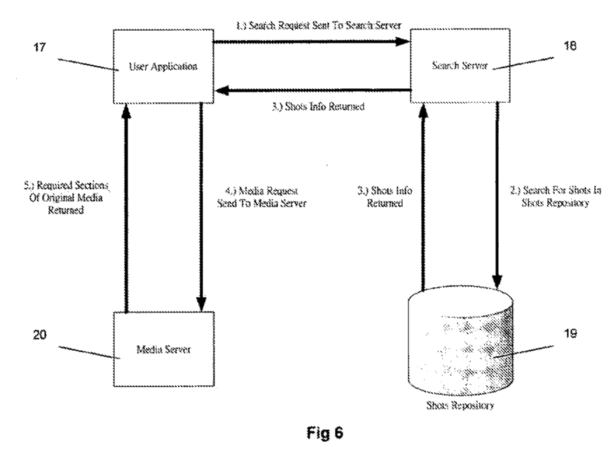

FIG. 6 shows the data flow in a media search. Search criterion is collected via User interface by the User Application 17 and a search request is made to the Search server 18. The Search server searches through the Shots Repository 19 for Shots that match the search criterion. The Shots Repository 19 returns the information on the Shots matching the given criterion. The Shots info is then returned to the user application 17. Based on the Shots info returned, the user application submits a request to the Media server 20 which processes the request and returns the sections of the Sequenced media as described by Shots info given.

While certain features and embodiments of the present invention have been described, other embodiments of the present invention will be apparent to those skilled in the art from consideration of the specification and practice of the embodiments of the invention disclosed herein. It is intended, therefore, that the specification and examples be considered as exemplary only, with a true scope and spirit of the present invention being indicated by the following claims and their full scope of equivalents.

1. A video file data representation method for representing video file data to be represented, said video file data to be represented carrying tags having fields allocated thereto at least one semantic reference and being constructed so that video file data carrying tags having the specified semantic reference are arranged and represented in series, comprising:
creating tags containing semantic references for video file data, the semantic references including information about records having a field with at least one semantic reference on the said video file data to be searched;
accepting an instruction to search for tags relating to a specified semantic reference on the said video file data to be searched;
retrieving from tags the information about records having specified semantic references on the said video file data to be searched;
extracting the video file data carrying tags having specified semantic references;
representing extracted video file data carrying the tags having the specified semantic references in series.

2. A video file data representation method for representing video file data to be represented, said video file data to be represented carrying tags having fields allocated thereto at least one semantic reference and further allocated thereto a specified layer in a multi-layer hierarchical structure and being constructed so that video file data carrying tags having the specified semantic reference and a specified layer are arranged and represented in series, comprising:
creating tags containing semantic references for video file data, the semantic references including information about records having a field with at least one semantic reference on the said video file data to be searched, and containing information of a specified layer by classifying the said semantic reference on the said video file data to be searched by using a plurality of hierarchical levels;
accepting an instruction to search for tags relating to a specified semantic reference on the said video file data to be searched;
accepting a further instruction to search for tags relating to a specified semantic reference and of a specified layer in the hierarchical levels on the said video file to be searched;
retrieving from tags the information about records having the specified semantic references and the specified layer in the hierarchical levels on the said video file data to be searched;
extracting the video file data carrying tags having specified semantic references and specified layer in the hierarchical levels;
representing extracted video file data carrying the tags having the specified semantic references and the specified layer in the hierarchical levels in series.

3. The video file data representation method of claim 1, wherein a content page shows a plurality of the extracted video file data and its tags. Thereby, the said representation supports representation of a plurality of video file data having N-to-N relationship and multiple access and multiple presentation.

4. The video file data representation method of 2, wherein the hierarchical structure includes a multiple six layers of scene, plot, play, shot, take, frame and object, in that a top layer denoting global information, the lower layer denoting comparatively primitive information and the lowest layer denoting most primitive information.

5. The video file data representation method of 2, wherein the hierarchical structure includes a six layers of scene, plot, play, shot, take, frame and object, in that a top layer denoting global information, the lower layer denoting comparatively primitive information and the lowest layer denoting most primitive information.

6. The video file data representation method of 2, wherein a plurality of the said video file data carrying tags having information of a specified semantic reference and a specified layer are hyper-linked and are presented in a series.

7. An apparatus for representing video file data to be represented, said video file data to be represented carrying tags having fields allocated thereto at least one semantic reference and being constructed so that video file data carrying tags having the specified semantic reference are arranged and represented in series, comprising:
a video file data or a plurality of video file data carrying tags containing semantic references, the semantic references including information about records having a field with at least one semantic reference on the said video file data to be searched;
an input unit for giving an instruction to search for tags relating to specified semantic reference on the said video file data to be searched;
a retrieving unit for retrieving from tags the information about records having specified semantic references on the said video file data to be searched;
an extracting unit for extracting the video file data carrying tags having specified semantic references; and
a representation unit for representing extracted video file data carrying the tags having the specified semantic references in series.

8. An apparatus for representing video file data to be represented, said video file data to be represented carrying tags having fields allocated thereto at least one semantic reference and further allocated thereto a specified layer in a multi-layer hierarchical structure and being constructed so that video file data carrying tags having the specified semantic reference and a specified layer are arranged and represented in series, comprising:
a video file data or a plurality of video file data tags carrying tags containing semantic references, the semantic references including information about records having a field with at least one semantic reference on the said video file data to be searched, and containing information of a specified layer by classifying semantic reference on the said video file data to be searched by using a plurality of hierarchical levels;
an input unit for giving an instruction to search for tags relating to specified semantic reference on the said video file data to be searched and to search for tags relating to a specified semantic reference and of a specified layer in the hierarchical levels on the said video file to be searched;
a retrieving unit for retrieving from tags the information about records having specified semantic references and a specified layer in the hierarchical levels on the said video file data to be searched;
an extracting unit for extracting the video file data carrying tags having specified semantic references and specified layer in the hierarchical levels;
a representation unit for representing extracted video file data carrying the tags having the specified semantic references and the specified layer in the hierarchical levels in series.

9. A computer readable memory product for instructing a computer to representing video file data to be represented, said video file data to be represented carrying tags having fields allocated thereto at least one semantic reference and being constructed so that video file data carrying tags having the specified semantic reference are arranged and represented in series, by using a plurality of tags containing semantic references for video file data, the semantic references including information about records having a field with at least one semantic reference on the said video file data to be searched, said memory product storing a program to instruct a computer to;
accept an instruction to search for tags relating to a specified semantic reference on the said video file data to be searched;
retrieve from tags the information about records having specified semantic references on the said video file data to be searched;
extract the video file data carrying tags having specified semantic references;
represent extracted video file data carrying the tags having the specified semantic references in series.

10. A computer readable memory product for instructing a computer to represent video file data to be represented, said video file data to be represented carrying tags having fields allocated thereto at least one semantic reference and further allocated thereto a specified layer in a multi-layer hierarchical structure and being constructed so that video file data carrying tags having the specified semantic reference are arranged and represented in series by using a plurality of tags containing semantic references for video file data, the semantic references including information about records having a field with at least one semantic reference on the said video file data to be searched, and containing information of a specified layer by classifying semantic reference on the said video file data to be searched by using a plurality of hierarchical levels, said memory product storing a product to instruct a computer to;
accept an instruction to search for tags relating to a specified semantic reference on the said video file data to be searched and to search for tags relating to a specified semantic reference and of a specified layer in the hierarchical levels on the said video file to be searched;
retrieve from tags the information about records having specified semantic references and a specified layer in the hierarchical levels on the said video file data to be searched;
extract the video file data carrying tags having specified semantic references and specified layer in the hierarchical levels; and
represent extracted video file data carrying the tags having the specified semantic references and the specified layer in the hierarchical levels in series.
